(19) United States
(12) Patent Application Publication
(10) Pub. No.: US 2020/0290609 A1
(43) Pub. Date: Sep. 17, 2020

(54) CONTROL DEVICE FOR VEHICLE

(71) Applicant: ADVICS CO., LTD., Aichi (JP)

(72) Inventors: Masayuki ASANO, Aichi (JP); Yukio MORI, Aichi (JP); Hiroyuki ANDO, Aichi (JP)

(21) Appl. No.: 16/084,003

(22) PCT Filed: Mar. 15, 2017
(86) PCT No.: PCT/JP2017/010344

§ 371 Date: Sep. 11, 2018

(30) Foreign Application Priority Data
Mar. 18, 2016 (JP) 2016-055751 2016

(51) Int. Cl. B60W 30/14; B60W 10/04; B60W 10/18

(52) U.S. Cl. CPC B60W 30/143; B60W 10/18; B60W 10/04

(57) ABSTRACT

Provided is a control device for a vehicle including an operation amount calculation unit for calculating, in a first travel mode using an automatic control that is not dependent on a driving operation by a driver, an operation amount for controlling a drive device and/or a braking device on a basis of a travel resistance value and a request value indicative of a level of acceleration of the vehicle; a correction value calculation unit for calculating, in a second travel mode based on the driving operation by the driver, a correction value corresponding to an error of the travel resistance from a drive output value, a travel resistance value, and an acceleration value obtained in a state where a predetermined condition is fulfilled; and a travel resistance value correction unit for correcting the travel resistance value with the correction value.

### TECHNICAL FIELD

The present invention relates to a control device for a vehicle.

### BACKGROUND ART

A technique of calculating a travel resistance value, which indicates travel resistance applied to a vehicle in accordance with a gradient of a road surface or the like, on the basis of a detection value by a sensor and executing automatic control of the vehicle such as cruise control in consideration of the calculated travel resistance value has been known.

### CITATION LIST

### Patent Literature

PTL 1: JP-A-2011-25914

### DISCLOSURE OF INVENTION

### Technical Problem

In the technique as described above, reliability of the detection value by the sensor is possibly lowered due to aging degradation or the like, and the travel resistance value, which is calculated on the basis of the detection value, possibly includes an error. Accordingly, it is desired to inhibit the execution of the automatic control that is based on the travel resistance value including the error, for example, when control is shifted from normal control, in which the vehicle travels in accordance with a driving operation by a driver, to the automatic control.

### Solution to Problem

A control device for a vehicle according to the present invention includes, for example: a drive output value acquisition unit that acquires a drive output value indicative of output of a drive device in the traveling vehicle; a travel resistance value acquisition unit that acquires a travel resistance value indicative of travel resistance applied to the traveling vehicle; an acceleration value acquisition unit that acquires an acceleration value indicative of longitudinal acceleration of the traveling vehicle; an operation amount calculation unit that calculates, in a first travel mode using automatic control that controls the longitudinal acceleration or deceleration of the vehicle without depending on a driving operation by a driver, an operation amount for controlling the drive device and/or a braking device on the basis of a request value indicative of a level of the longitudinal acceleration of the vehicle and the travel resistance value; a correction value calculation unit that calculates, in a second travel mode based on the driving operation by the driver, a correction value corresponding to an error in the travel resistance from the drive output value, the travel resistance value, and the acceleration value acquired in a state where a predetermined condition is fulfilled; and a travel resistance value correction unit that corrects the travel resistance value with the correction value at least initially after the second travel mode is switched to the first travel mode. In this way, it is possible to inhibit execution of the automatic control based on the travel resistance value including the error when the second travel mode is shifted to the first travel mode.

In the control device for the vehicle described above, for example, the correction value calculation unit calculates the correction value on the basis of a difference between the travel resistance value and a difference between the drive output value and the acceleration value. In this way, the correction value can be calculated by calculating the error in the travel resistance value on the basis of a value considered as a true value of the travel resistance value that is acquired from the difference between the drive output value and the acceleration value.

In the control device for the vehicle described above, for example, the predetermined condition includes such a condition that a change in the acceleration value in a predetermined period falls within a first range. In this way, the correction value can be calculated in a state where a travel state of the vehicle is stable to a certain extent.

In the control device for the vehicle described above, for example, the predetermined condition includes such a condition that a change in the drive output value in the predetermined period falls within a second range. In this way, the correction value can be calculated in the state where the travel state of the vehicle is stable to a certain extent.

In the control device for the vehicle described above, for example, the correction value calculation unit updates the correction value in the case where a state of fulfilling the predetermined condition continues. In this way, the travel resistance value can be corrected by using the latest correction value.

### BRIEF DESCRIPTION OF DRAWINGS

FIG. 1 is a block diagram exemplifying an overall configuration of a vehicle control system that includes a forward/reverse acceleration control device according to an embodiment.

FIG. 2 is a block diagram exemplifying an internal configuration of the forward/reverse acceleration control device according to the embodiment.

FIG. 3 is an exemplary chart illustrating an influence of a case where a travel resistance value includes an error in the embodiment.

FIG. 4 is an exemplary chart illustrating a condition under which a correction value is calculated in the forward/reverse acceleration control device according to the embodiment.

FIG. 5 is an exemplary view illustrating the condition under which the correction value is calculated in the forward/reverse acceleration control device according to the embodiment from a different perspective from FIG. 4.

FIG. 6 is an exemplary flowchart illustrating processing that is executed by the forward/reverse acceleration control device according to the embodiment in a normal travel mode.

FIG. 7 is an exemplary flowchart illustrating processing that is executed by the forward/reverse acceleration control device according to the embodiment in a cruise control mode.

### DESCRIPTION OF EMBODIMENT

A description will hereinafter be made on an embodiment of the present invention on the basis of the drawings. Each of a configuration of the embodiment, which will be described below, action and results (effects) brought by said configuration is merely one example and is not limited to the following description.

First, a description will be made on a configuration of a forward/reverse acceleration control device 3 according to the embodiment. The forward/reverse acceleration control device 3 is an example of the “control device for a vehicle”.

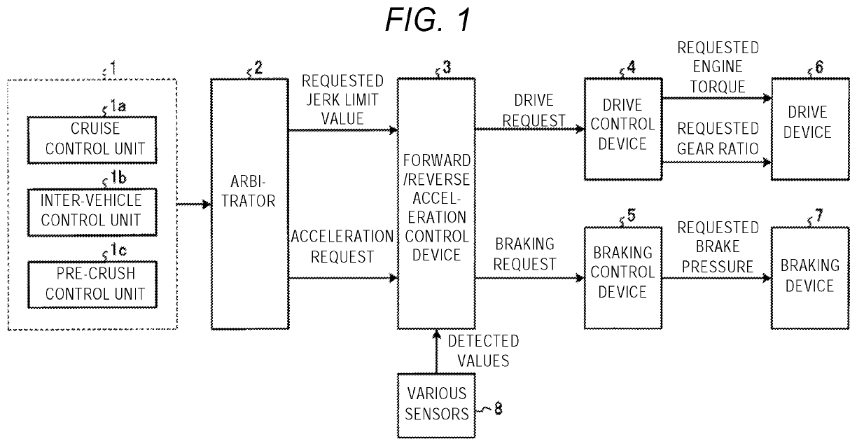

FIG. 1 is a block diagram exemplifying an overall configuration of a vehicle control system that includes the forward/reverse acceleration control device 3 according to the embodiment. This vehicle control system is mounted on a vehicle that can travel in two types of control modes including: a cruise control mode in which the vehicle travels by using automatic control not dependent on a driving operation by a driver; and a normal travel mode in which the vehicle travels in accordance with the driving operation by the driver. Note that the cruise control mode is an example of the “first travel mode” and the normal travel mode is an example of the “second travel mode”.

As illustrated in FIG. 1, the vehicle control system includes: an acceleration request unit 1, an arbitrator 2, the forward/reverse acceleration control device 3, a drive control device 4, a braking control device 5, a drive device 6, a braking device 7, and various sensors 8.

The acceleration request unit 1 outputs an acceleration request value corresponding to a state of the traveling vehicle in the case where the vehicle travels in the cruise control mode. More specifically, the acceleration request unit 1 includes, as applications for realizing the cruise control mode, a cruise control unit 1a, an inter-vehicle control unit lb, and a pre-crush control unit 1c. The cruise control unit 1a outputs a request value for controlling a travel speed of the vehicle (hereinafter described as a vehicle speed) to a predetermined value. The inter-vehicle control unit lb outputs a request value for controlling an inter-vehicular distance from a preceding vehicle to fall within a predetermined range. The pre-crush control unit 1c outputs a request value for avoiding a collision with the preceding vehicle.

The arbitrator 2 receives the request values from the acceleration request unit 1, arbitrates the acceleration indicated by the request values, and outputs, as an acceleration request from each of the applications in the acceleration request unit 1, change amounts of the request values in a control cycle, that is, a jerk that is a differential value of longitudinal acceleration of the vehicle. In addition, the arbitrator 2 calculates a limit value of the jerk that is set in accordance with the state of the traveling vehicle, and outputs the calculation result as a requested jerk limit value.

The forward/reverse acceleration control device 3 calculates a drive request and a braking request on the basis of the acceleration request and the requested jerk limit value received from the arbitrator 2 as well as detection values received from the various sensors 8. Here, the various sensors are configured by including plural sensors capable of detecting necessary information for control of the vehicle, and the plural sensors include: a sensor that detects an engine speed (proportional to the vehicle speed) ; an acceleration sensor that detects the acceleration generated in the vehicle; and a stroke sensor that detects a driving operation amount by the driver (a pedal stroke). Thus, the forward/reverse acceleration control device 3 receives, as the detection values, data on the vehicle speed, data on the acceleration applied to the vehicle, data on the driving operation amount by the driver (the pedal stroke), data on a fuel injection amount in the engine, and the like.

The drive control device 4 controls the drive device 6 for driving the vehicle. For example, the drive control device 4 is constructed of a powertrain ECU (an electronic control unit) that controls a powertrain as an example of the drive device 6. In accordance with the drive request received from the forward/reverse acceleration control device 3, the drive control device 4 calculates an engine torque request value (requested engine torque) and a transmission gear ratio request value (a requested gear ratio) and outputs the calculation results to the drive device 6.

The braking control device 5 is constructed of a brake ECU that controls the braking device 7 for braking the vehicle . In accordance with the braking request received from the forward/reverse acceleration control device 3, the braking control device 5 calculates a request value of a wheel cylinder pressure that is generated by a brake actuator (a requested brake pressure), and outputs the calculation result to the braking device 7.

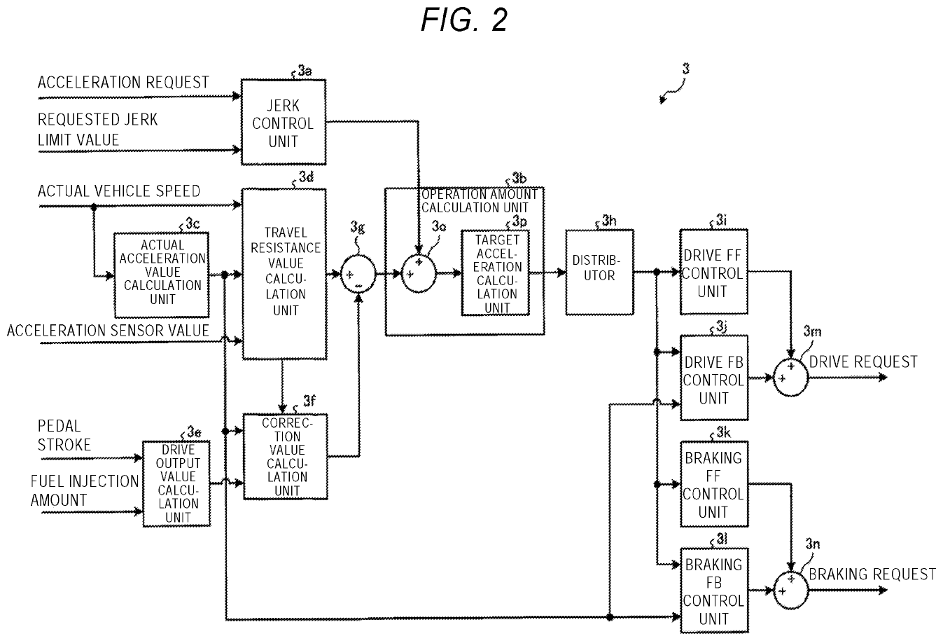

FIG. 2 is a block diagram exemplifying an internal configuration of the forward/reverse acceleration control device 3 according to the embodiment. As illustrated in FIG. 2, the forward/reverse acceleration control device 3 includes a jerk control unit 3a, an operation amount calculation unit 3b, an actual acceleration value calculation unit 3c, a travel resistance value calculation unit 3d, a drive output value calculation unit 3e, a correction value calculation unit 3f, and a subtractor 3g. Note that the actual acceleration value calculation unit 3c, the travel resistance value calculation unit 3d, and the drive output value calculation unit 3e are examples of the “acceleration value acquisition unit”, the “travel resistance value acquisition unit”, and the “drive output value acquisition unit”, respectively. The subtractor 3g is an example of the “travel resistance value correction unit”. Furthermore, the forward/reverse acceleration control device 3 includes a distributor 3h, a drive feedforward (hereinafter described as FF) control unit 3i, a drive feedback (FB) control unit 3j, a braking FF control unit 3k, a braking FB control unit 3l, an adder 3m, and an adder 3n.

The jerk control unit 3a calculates the acceleration that corresponds to the acceleration request received from the arbitrator 2 while limiting an acceleration change amount on the basis of the requested jerk limit value received from the arbitrator 2, and outputs the calculation result as a request value to the operation amount calculation unit 3b.

The operation amount calculation unit 3b calculates an operation amount that corresponds to a control command for each of the drive control device 4 and the braking control device 5 on the basis of the request value received from the jerk control unit 3a and a travel resistance value received from the subtractor 3g (the travel resistance value after correction and a detail thereof will be described below). More specifically, the operation amount calculation unit 3b includes an adder 3o and a target acceleration calculation unit 3p. The adder 3o adds the request value received from the jerk control unit 3a and the travel resistance value received from the subtractor 3g. On the basis of the addition result by the adder 3o, the target acceleration calculation unit 3p calculates target acceleration that should be generated in the vehicle, and outputs the calculation result as the operation amount.

The actual acceleration value calculation unit 3c acquires an acceleration value that indicates the longitudinal acceleration of the traveling vehicle. More specifically, the actual acceleration value calculation unit 3c calculates an acceleration value that is actually generated in the vehicle (hereinafter described as an actual acceleration value) on the basis of an actual vehicle speed detection value. Note that the actual acceleration corresponds to a time differential of the actual vehicle speed.

The travel resistance value calculation unit 3d acquires the travel resistance value that indicates travel resistance applied to the traveling vehicle. More specifically, the travel resistance value calculation unit 3d calculates (estimates) the travel resistance value on the basis of the actual vehicle speed detection value, the detection value of the acceleration sensor (an acceleration sensor value), and the actual acceleration value. Here, the travel resistance corresponds to a sum of forces (accelerations), each of which acts in a direction to interfere with the travel of the vehicle, and includes, for example: the acceleration that is applied to the vehicle in accordance with a gradient of a road surface (gradient resistance); rolling resistance that is generated in each tire; air resistance that is applied to a vehicle body; and the like. Note that, in the embodiment, the travel resistance value may be calculated not only in consideration of three types of the detection values including the actual vehicle speed detection value, the acceleration sensor value, and the actual acceleration value but also in consideration of a detection value(s) other than these. Here, the travel resistance value is the “force”. Thus, in order to compare the travel resistance value with the “acceleration” such as the acceleration request value or the actual acceleration or to add or subtract these values, the travel resistance value has to be converted to a value that corresponds to the “acceleration”. For this reason, on the basis of the calculated travel resistance value, the travel resistance calculation unit 3d calculates a travel resistance corresponding acceleration value that is a value acquired by converting the travel resistance value to the acceleration. The travel resistance corresponding acceleration value can be calculated by dividing the travel resistance value by predetermined vehicle mass or dividing the travel resistance value by a value that is acquired by adding inertia moment of a portion that rotates in conjunction with the travel, such as the tire, to the predetermined vehicle mass, for example.

The drive output value calculation unit 3e acquires a drive output value that indicates output of the drive device 6 in the traveling vehicle. More specifically, the drive output value calculation unit 3e calculates the drive output value on the basis of the detection value of the pedal stroke and the detection value of the fuel injection amount. Note that, in the embodiment, a map that stores a corresponding relationship between the pedal stroke (and/or the fuel injection amount) and the drive output value may be used to determine the drive output value in accordance with the detection value of the pedal stroke (and/or the fuel injection amount). Here, similar to the above travel resistance value, the drive output value is the “force”. Thus, in order to compare the drive output value with the “acceleration” such as the requested acceleration or the actual acceleration or to add or subtract these values, the drive output value has to be converted to the value that corresponds to the “acceleration”. For this reason, on the basis of the calculated drive output value, the drive output calculation unit 3e calculates a drive output corresponding acceleration value that is a value acquired by converting the drive output value to the acceleration. The drive output corresponding acceleration value can be calculated by dividing the drive output value by the predetermined vehicle mass or dividing the drive output value by the value acquired by adding the inertia moment of the portion that rotates in conjunction with the travel, such as the tire, to the predetermined vehicle mass, for example.

By the way, in general, reliability of the detection value of the acceleration sensor or the like changes in accordance with aging degradation, a temperature condition, and the like. Thus, the calculation result using the detection value may not always match the actual value. For example, as described above, the travel resistance value calculation unit 3d according to the embodiment calculates the travel resistance value on the basis of the three types of the detection values including the acceleration sensor value. Thus, in the case where the reliability of any of the detection values is lowered, the travel resistance value, which is calculated by the travel resistance value calculation unit 3d, possibly includes an error. In the case where the travel resistance value includes the error, the error may adversely affect the calculation of the operation amount by the operation amount calculation unit 3b when the normal travel mode is shifted to the cruise control mode, for example.

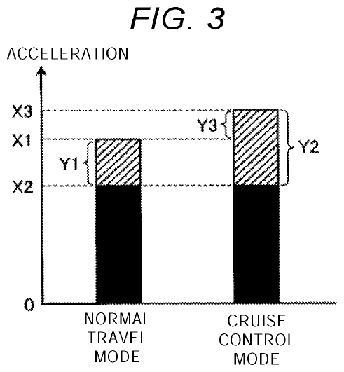

FIG. 3 is an exemplary chart for illustrating an influence of the case where the travel resistance value includes the error in the embodiment . A dimension of a vertical axis in FIG. 3 is a dimension of the acceleration.

A diagram on the left side of FIG. 3 illustrates an example that, despite a fact that the drive output corresponding acceleration value is X1 in the normal travel mode, the actual acceleration value is X2 that is lower than X1. In this example, it is considered that the actual acceleration value is lower than the drive output corresponding acceleration value because the travel resistance is applied to the vehicle. Thus, in the diagram on the left side of FIG. 3, it is considered that Y1 as a difference between X1 and X2 is the acceleration value that corresponds to the actually generated travel resistance.

Here, a case where the control mode of the vehicle is switched from the normal travel mode to the cruise control mode will be considered. In this case, in order to suppress a rapid change in the acceleration, which is generated in the vehicle, before and after switching of the control mode, the actual acceleration value has to be maintained in consideration of the travel resistance applied to the vehicle. Thus, the acceleration that is requested to the vehicle in the cruise control mode is basically a sum of the actual acceleration value, which is calculated by the actual acceleration value calculation unit 3c, and the travel resistance corresponding acceleration value, which is calculated by the travel resistance value calculation unit 3d.

As described above, since the travel resistance value, which is calculated by the travel resistance value calculation unit 3d, is the value based on the detection values such as the acceleration sensor value, the travel resistance value possibly includes the error. Thus, in the cruise control mode, the travel resistance value that differs from the travel resistance value actually generated in the normal travel mode (more specifically, a resistance value that corresponds to a difference between the actual acceleration value and the drive output value) is possibly calculated.

A diagram on the right side of FIG. 3 illustrates an example that a travel resistance corresponding acceleration value Y2, which is acquired by converting the travel resistance value calculated in the cruise control mode to the acceleration value, is higher than the acceleration value Y1 by the travel resistance value generated in the normal travel mode. In this example, target acceleration X3 that is acquired by adding the travel resistance corresponding acceleration value Y2 and the actual acceleration X2 is higher than the acceleration X1 that is acquired by adding the actual acceleration X2 and the acceleration value Y1 corresponding to the actually generated travel resistance. Thus, in order to suppress the rapid change in the acceleration, which is generated in the vehicle, before and after switching of the control mode, it is desired to correct the travel resistance value, which is calculated by the travel resistance value calculation unit 3d, on the basis of a difference Y3 between Y2 and Y1 (the acceleration by the error in the travel resistance value).

Here, the travel resistance corresponding acceleration value Y2, which is calculated on the basis of the detection values, can also be calculated in the normal travel mode. Thus, in the embodiment, it is desired to calculate the acceleration value Y1, which corresponds to the travel resistance actually generated in the normal travel mode, and the travel resistance corresponding acceleration Y2 by different methods from each other, calculate the difference Y3 between the acceleration value Y1, which corresponds to said actually generated travel resistance, and the travel resistance corresponding acceleration Y2 in advance as a correction value, and thereby correct the travel resistance value, which is calculated on the basis of the detection values, after the control mode is shifted to the cruise control mode.

Returning to FIG. 2, the following configuration is provided in the embodiment to correct the error in the travel resistance value.

The correction value calculation unit 3f calculates the correction value corresponding to the error in the travel resistance value, which is calculated by the travel resistance value calculation unit 3d, on the basis of the actual acceleration value, the travel resistance corresponding acceleration value, and the drive output corresponding acceleration value, which are respectively acquired from the actual acceleration value calculation unit 3c, the travel resistance value calculation unit 3d, and the drive output value calculation unit 3e. More specifically, the correction value calculation unit 3f calculates the correction value on the basis of the difference between the travel resistance corresponding acceleration value and the difference between the drive output corresponding acceleration value and the actual acceleration value. The correction value is calculated in the normal travel mode.

Note that, in general, the cruise control mode is realized in a manner that the control mode is shifted from the normal travel mode. Thus, in the embodiment, the correction value has already been calculated when the control mode of the vehicle is switched from the normal travel mode to the cruise control mode. The correction value calculation unit 3f outputs the correction value, which is calculated in advance, to the subtractor 3g at least initially after the normal travel mode is switched to the cruise control mode. Then, the subtractor 3g subtracts the correction value, which is received from the correction value calculation unit 3f, from the travel resistance corresponding acceleration value, which is received from the travel resistance value calculation unit 3d, and outputs the subtraction result to the operation amount calculation unit 3b. Just as described, in the embodiment, the subtractor 3g corrects the travel resistance corresponding acceleration value, which is calculated by the travel resistance value calculation unit 3d, at least initially after the normal travel mode is switched to the cruise control mode.

Here, in order to further accurately calculate the correction value, it is desired that a travel state of the vehicle is a stable state to a certain extent (hereinafter described as the stable state). That is, in the embodiment, the correction value is desirably calculated in a state where a change in each of the acceleration value and the drive output value in a predetermined period falls within a certain range, for example.

Accordingly, in the embodiment, in the case where such a condition that the control mode of the vehicle is the normal travel mode and the travel state of the vehicle is the stable state is fulfilled, the correction value calculation unit 3f acquires the actual acceleration value, the travel resistance value, and the drive output value and calculates the correction value on the basis of the acquired actual acceleration value, travel resistance value, and drive output value.

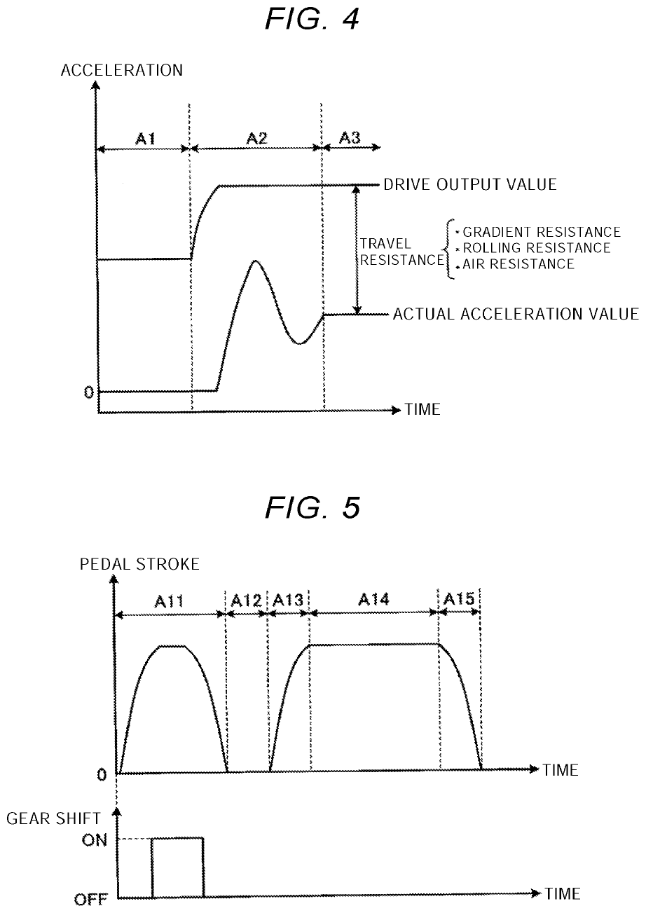

FIG. 4 is an exemplary chart for illustrating the condition under which the correction value is calculated in the forward/reverse acceleration control device according to the embodiment. In the example of FIG. 4, while the drive output value and the actual acceleration value have constant values in sections A1 and A3, the drive output value and the actual acceleration value fluctuate in a section A2. That is, in the example of FIG. 4, the sections A1 and A3 correspond to the stable state, and the section A2 corresponds to a so-called transient state that differs from the stable state. Thus, in the example of FIG. 4, while the correction value is calculated in the sections A1 and A3, the correction value is not calculated in the section A2.

Note that the stable state is not limited to a state where the change in each of the actual acceleration value and the drive output value in the predetermined period falls within the certain range. For example, a state where a change in the pedal stroke or the fuel injection amount in the predetermined period falls within a certain range may also be determined to correspond to the stable state. Furthermore, whether the gear ratio of the transmission is not currently switched may be considered as a determination criterion that is used to determine whether such a state corresponds to the stable state.

FIG. 5 is an exemplary view for illustrating the condition under which the correction value is calculated in the forward/reverse acceleration control device according to the embodiment from a different perspective from FIG. 4. In the example of FIG. 5, while the pedal stroke has a constant value in sections A12 and A14, the pedal stroke fluctuates in sections A13 and A15. Thus, in the example of FIG. 5, the sections A12 and A14 correspond to the stable state, and the sections A13 and A15 correspond to the transient state. Note that, in the example in FIG. 5, a section A11 also includes a section in which the pedal stroke has the constant value. However, because the gear ratio of the transmission is being switched in the section All, the section All does not correspond to the stable state.

Here, in the embodiment, a predetermined condition is that the travel state of the vehicle is the stable state, and in the case where a state of filling the predetermined condition continues, the correction value calculation unit 3f updates the correction value. That is, while the control mode of the vehicle is the normal travel mode and the travel state of the vehicle is the stable state, the correction value calculation unit 3f repeatedly calculates the correction value and thereby updates the past correction value by the latest correction value.

Returning to FIG. 2, the distributor 3h distributes and outputs the operation amount, which is received from the operation amount calculation unit 3b, to the drive FF control unit 3i, the drive FB control unit 3j, the braking FF control unit 3k, and the braking FB control unit 3l.

The drive FF control unit 3i outputs an FF command value that corresponds to the input from the distributor 3h. The drive FB control unit 3j outputs an FB command value that corresponds to the input from the distributor 3h and the input from the actual acceleration value calculation unit 3c. Then, the adder 3m adds the input from the drive FF control unit 3i and the input from the drive FB control unit 3j and outputs the addition result as the drive request to the drive control device 4.

The braking FF control unit 3k outputs the FF command value that corresponds to the input from the distributor 3h. The braking FB control unit 3l outputs the FB command value that corresponds to the input from the distributor 3h and the input from the actual acceleration value calculation unit 3c. Then, the adder 3n adds the input from the braking FF control unit 3k and the input from the braking FB control unit 3l and outputs the addition result as the braking request to the braking control device 5.

Next, a description will be made on a braking operation of the forward/reverse acceleration control device 3 according to the embodiment.

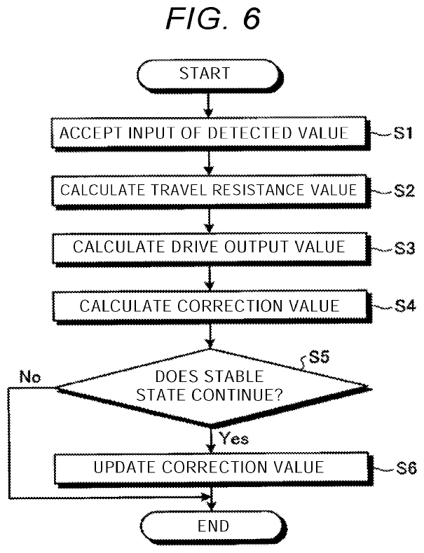

FIG. 6 is an exemplary flowchart illustrating processing that is executed by the forward/reverse acceleration control device 3 according to the embodiment in the normal travel mode . This processing flow in FIG. 6 is repeatedly executed in the normal travel mode, for example.

In the processing flow of FIG. 6, first, in S1, the actual acceleration value calculation unit 3c, the travel resistance value calculation unit 3d, and the drive output value calculation unit 3e accept input of the detection values from the various sensors 8. The actual acceleration value calculation unit 3c receives the actual vehicle speed detection value, the travel resistance value calculation unit 3d receives the actual vehicle speed detection value and the acceleration sensor value, and the drive output value calculation unit 3e receives the detection values of the pedal stroke and the fuel injection amount. Note that the travel resistance value calculation unit 3d also receives the actual acceleration value, which is calculated by the actual acceleration value calculation unit 3c on the basis of the sensor value indicative of the actual vehicle speed.

In S2, the travel resistance value calculation unit 3d calculates the travel resistance value on the basis of the actual vehicle speed detection value, the actual acceleration value, and the acceleration sensor value. More specifically, the travel resistance value calculation unit 3d calculates the travel resistance value (and the travel resistance corresponding acceleration value) by adding the gradient resistance, the rolling resistance, the air resistance, and the like that are estimated on the basis of the above various input values.

In S3, the drive output value calculation unit 3e calculates the drive output value (and the drive output corresponding acceleration value) on the basis of the detection value of the pedal stroke and the detection value of the fuel injection amount.

In S4, the correction value calculation unit 3f calculates the correction value on the basis of the drive output corresponding acceleration value, the travel resistance value corresponding acceleration, and the actual acceleration value. More specifically, the correction value calculation unit 3f calculates the correction value from the difference between the travel resistance corresponding acceleration value (the value calculated on the basis of the detection value) and the difference between the drive output corresponding acceleration value and the actual acceleration value (the value considered as a true value of the travel resistance corresponding acceleration value).

In S5, the correction value calculation unit 3f determines whether the stable state continues. More specifically, the correction value calculation unit 3f determines whether the change in each of the actual acceleration value and the drive output value in the predetermined period falls within the certain range, whether the change in the pedal stroke (or the fuel injection amount) in the predetermined period falls within the certain range, and the like. Note that, at this time, whether the gear ratio of the transmission is not currently switched may be considered as the determination criterion.

If it is determined in S5 that the stable state continues, the processing proceeds to S6. Then, in S6, the correction value calculation unit 3f updates the correction value stored therein to the latest correction value that is calculated in last S4. Then, the processing is terminated.

On the other hand, if it is determined in S5 that the stable state does not continue, the processing as in S6 is not executed, and the processing is terminated as is. That is, if it is determined in S5 that the stable state does not continue, the correction value calculation unit 3f stores the correction value stored therein as the latest correction value, and the processing is terminated.

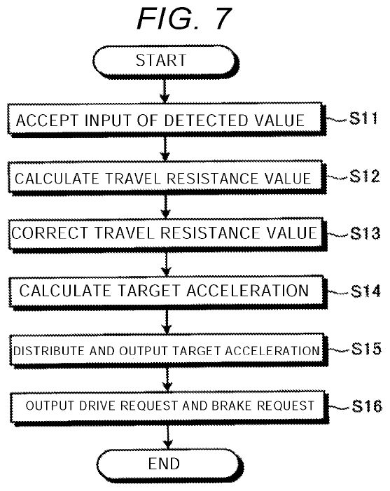

FIG. 7 is an exemplary flowchart illustrating processing that is executed by the forward/reverse acceleration control device 3 according to the embodiment in the cruise control mode . This processing flow in FIG. 7 is executed initially after the control mode of the vehicle is switched from the normal travel mode to the cruise control mode.

In the processing flow of FIG. 7, first, in S11, the actual acceleration value calculation unit 3c and the travel resistance value calculation unit 3d accept the input of the detection values from the various sensors 8. The actual acceleration value calculation unit 3c receives the actual vehicle speed detection value, and the travel resistance value calculation unit 3d receives the actual vehicle speed detection value and the acceleration sensor value. Note that the travel resistance value calculation unit 3d also receives the actual acceleration value, which is calculated by the actual acceleration value calculation unit 3c on the basis of the sensor value indicative of the actual vehicle speed.

In S12, the travel resistance value calculation unit 3d calculates the travel resistance value (and the travel resistance corresponding acceleration value) by adding the gradient resistance, the rolling resistance, the air resistance, and the like that are estimated on the basis of the above various input values.

In S13, the subtractor 3g corrects the travel resistance value, which is received from the travel resistance value calculation unit 3d, on the basis of the correction value, which is received from the correction value calculation unit 3f. More specifically, the subtractor 3g subtracts the correction value from the travel resistance value and outputs the subtraction result to the operation amount calculation unit 3b.

In S14, the operation amount calculation unit 3b calculates the target acceleration that should be generated in the vehicle on the basis of the request value received from the jerk control unit 3a and the travel resistance value (after the correction) received from the subtractor 3g. More specifically, the adder 3o of the operation amount calculation unit 3b adds the request value and the travel resistance corresponding acceleration value and outputs the addition result. Then, the target acceleration calculation unit 3p of the operation amount calculation unit 3b calculates the operation amount on the basis of the input from the adder 3o.

In S15, the distributor 3h distributes and outputs the target acceleration, which is received from the operation amount calculation unit 3b, to the drive FF control unit 3i, the drive FB control unit 3j, the braking FF control unit 3k, and the braking FB control unit 3l.

In S16, the forward/reverse acceleration control device 3 outputs the drive request to the drive control device 4 and the braking request to the braking control device 5. More specifically, the adder 3m outputs the drive request that is based on the FF command value from the drive FF control unit 3i and the FB command value from the drive FB control unit 3j, and the adder 3n outputs the braking request that is based on the FF command value from braking FF control unit 3k and the FB command value from the braking FB control unit 3l. Then, the processing is terminated.

As it has been described so far, the forward/reverse acceleration control device 3 according to the embodiment includes: the correction value calculation unit 3f that calculates the correction value corresponding to the error in the travel resistance from the drive output corresponding acceleration value, the travel resistance corresponding acceleration value, and the actual acceleration value acquired in the state where the predetermined condition is fulfilled in the normal travel mode; and the subtractor 3g that corrects the travel resistance corresponding acceleration value with the correction value at least initially after the normal travel mode is switched to the cruise control mode. In this way, it is possible to inhibit the execution of the automatic control based on the travel resistance value including the error when the normal travel mode is shifted to the cruise control mode.

In addition, the correction value calculation unit 3f according to the embodiment calculates the correction value on the basis of the difference between the travel resistance corresponding acceleration value and the difference between the drive output corresponding acceleration value and the actual acceleration value. In this way, the correction value can be calculated by calculating the error in the travel resistance value on the basis of the value considered as the true value of the travel resistance value, which is acquired from the difference between the drive output value and the actual acceleration value.

In the embodiment, the predetermined condition to calculate the correction value includes such a condition that the change in the actual acceleration value in the predetermined period falls within the certain range (a first range). In this way, the correction value can be calculated in the state where the travel state of the vehicle is stable to a certain extent.

Similarly, in the embodiment, the predetermined condition to calculate the correction value includes such a condition that the change in the drive output value in the predetermined period falls within the certain range (a second range). In this way, the correction value can be calculated in the state where the travel state of the vehicle is stable to a certain extent.

In the case where the state of fulfilling the above predetermined condition continues, the correction value calculation unit 3f according to the embodiment updates the correction value. In this way, the travel resistance value can be corrected by using the latest correction value.

The embodiment and the modified examples of the present invention have been described so far. Each of the embodiment and the modified examples described above is merely one example and thus has no intention to limit the scope of the invention. Each of the embodiment and the modified examples described above can be implemented in any of various modes, and various types of elimination, replacement, and changes can be made thereto within the scope that does not depart from the gist of the invention. In addition, the embodiment and the modified examples described above are included in the scope and the gist of the invention and are also included in the invention described in the claims and the equivalent scope thereof.

1. A control device for a vehicle comprising:
a drive output value acquisition unit that acquires a drive output value indicative of output of a drive device in the traveling vehicle;
a travel resistance value acquisition unit that acquires a travel resistance value indicative of travel resistance applied to the traveling vehicle;
an acceleration value acquisition unit that acquires an acceleration value indicative of longitudinal acceleration of the traveling vehicle;
an operation amount calculation unit that calculates, in a first travel mode using automatic control that controls the longitudinal acceleration or deceleration of the vehicle without depending on a driving operation by a driver, an operation amount for controlling the drive device and/or a braking device on the basis of a request value indicative of a level of the longitudinal acceleration of the vehicle and the travel resistance value;
a correction value calculation unit that calculates, in a second travel mode based on the driving operation by the driver, a correction value corresponding to an error in the travel resistance from the drive output value, the travel resistance value, and the acceleration value acquired in a state where a predetermined condition is fulfilled; and
a travel resistance value correction unit that corrects the travel resistance value with the correction value at least initially after the second travel mode is switched to the first travel mode.

2. The control device for the vehicle according to claim 1, wherein the correction value calculation unit calculates the correction value on the basis of a difference between the travel resistance value and a difference between the drive output value and the acceleration value.

3. The control device for the vehicle according to claim 1, wherein
the predetermined condition includes such a condition that a change in the acceleration value in a predetermined period falls within a first range.

4. The control device for the vehicle according to claim 1, wherein
the predetermined condition includes such a condition that a change in the drive output value in the predetermined period falls within a second range.

5. The control device for the vehicle according to claim 1, wherein
the correction value calculation unit updates the correction value in the case where a state where the predetermined condition is fulfilled continues.

6. The control device for the vehicle according to claim 2, wherein
the predetermined condition includes such a condition that a change in the acceleration value in a predetermined period falls within a first range.

7. The control device for the vehicle according to claim 2, wherein
the predetermined condition includes such a condition that a change in the drive output value in the predetermined period falls within a second range.

8. The control device for the vehicle according to claim 3, wherein
the predetermined condition includes such a condition that a change in the drive output value in the predetermined period falls within a second range.

9. The control device for the vehicle according to claim 2, wherein
the correction value calculation unit updates the correction value in the case where a state where the predetermined condition is fulfilled continues.

10. The control device for the vehicle according to claim 3, wherein
the correction value calculation unit updates the correction value in the case where a state where the predetermined condition is fulfilled continues.

11. The control device for the vehicle according to claim 4, wherein
the correction value calculation unit updates the correction value in the case where a state where the predetermined condition is fulfilled continues.
